(19) United States
(12) Patent Application Publication
(10) Pub. No.: US 2026/0310878 A1
(43) Pub. Date: Oct. 8, 2026

(54) ADAPTIVE, COMPONENT-LEVEL DATA RENDERING USING PREDICTIVE MODELS

(71) Applicant: Capital One Services, LLC, McLean, VA (US)

(72) Inventors: Bryan TAMAYO, Allen, TX (US); William MERKEL, Garland, TX (US)

(21) Appl. No.: 19/169,710

(22) Filed: Apr. 3, 2025

(51) Int. Cl. G06F 40/14; G06F 3/0484

(52) U.S. Cl. CPC G06F 40/14; G06F 3/0484

(57) ABSTRACT

In some implementations, a system may receive, for dynamically updating content of a website, user interaction data identifying a set of interactions with the website. The system may generate for a set of components corresponding to the dynamically updating content of the website, and using an analytics model, a set of determinations of whether to perform re-rendering operations based on the user interaction data. The system may perform, based on generating the set of determinations, the re-rendering operations to dynamically update a subset of the set of components. The system may cause the website to be provided for display with the subset of the set of components re-rendered.

### BACKGROUND

A web browser, on a client device, may render a website by interpreting HyperText Markup Language (HTML), cascading style sheets (CSS), and JavaScript. The web browser may parse the HTML to construct a Document Object Model (DOM) and apply CSS rules to style elements. A rendering engine, of the client device, may calculate a layout and generate visual elements for display on a screen. JavaScript execution, on the client device, may modify the DOM dynamically and update the rendered content. The web browser may continuously regenerate and reflow the content as a response to user interactions or network events.

### SUMMARY

Some implementations described herein relate to a system for data rendering. The system may include one or more memories and one or more processors communicatively coupled to the one or more memories. The one or more processors may be configured to receive, for a user interface, user interaction data identifying a set of interactions with the user interface. The one or more processors may be configured to generate, for a set of components of a rendered user interface and using an artificial intelligence or machine learning (AI/ML) model, an ordering based on the user interaction data, wherein the ordering is indicative of a likelihood of a future interaction with a corresponding component, of the set of components. The one or more processors may be configured to determine, for the set of components, to perform a re-rendering operation for the rendered user interface based on the ordering. The one or more processors may be configured to instruct, based on determining to perform the re-rendering operation, a rendering engine to re-render at least a subset of the set of components to generate a re-rendered user interface. The one or more processors may be configured to cause the re-rendered user interface to be provided for display with at least the subset of the set of components.

Some implementations described herein relate to a non-transitory computer-readable medium that stores a set of instructions. The set of instructions, when executed by one or more processors of a system, may cause the system to receive, from a client device and for a webpage, user interaction data identifying a set of interactions with a user interface that provides the webpage. The set of instructions, when executed by one or more processors of the system, may cause the system to generate, for a set of components of the webpage and using an AI/ML model, a set of priorities based on the user interaction data. The set of instructions, when executed by one or more processors of the system, may cause the system to select a subset of the set of components for which to perform a re-rendering operation in accordance with the set of priorities. The set of instructions, when executed by one or more processors of the system, may cause the system to re-render, based on selecting the subset of the set of components, the webpage, wherein the webpage includes a first portion, corresponding to the subset of the set of components, that is re-rendered, and a second portion, corresponding to a remainder of the set of components, that is not re-rendered. The set of instructions, when executed by one or more processors of the system, may cause the system to provide the webpage for display via the user interface based on re-rendering the webpage.

Some implementations described herein relate to a method for adaptive webpage rendering. The method may include receiving, by a system, for dynamically updating content of a website, user interaction data identifying a set of interactions with the website. The method may include generating, by the system, for a set of components corresponding to the dynamically updating content of the website, and using an analytics model, a set of determinations of whether to perform re-rendering operations based on the user interaction data. The method may include performing, based on generating the set of determinations, the re-rendering operations to dynamically update a subset of the set of components. The method may include causing, by the system, the website to be provided for display with the subset of the set of components re-rendered.

### BRIEF DESCRIPTION OF THE DRAWINGS

FIGS. 1A-1D are diagrams of an example associated with adaptive, component-level data rendering using predictive models, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with adaptive, component-level data rendering using predictive models, in accordance with some embodiments of the present disclosure.

FIG. 4 is a flowchart of an example process associated with adaptive, component-level data rendering using predictive models, in accordance with some embodiments of the present disclosure.

### DETAILED DESCRIPTION

The following detailed description of example implementations refers to the accompanying drawings. The same reference numbers in different drawings may identify the same or similar elements.

A client device may provide a web browser or other user interface in which the client device renders components of data, such as components of a website. Periodically, data in a component of a website may change. When the user interface is refreshed, the client device may request and receive updated data for a component in the user interface. For example, when a website includes a component for displaying a dataset, the client device may periodically request an updated dataset and provide the updated dataset for display. Additionally, or alternatively, when a website includes a component for displaying a video, the client device may periodically request an updated image, video stream, or video segment for display via the component. However, a static approach to updating components of a user interface may result in out-of-date data being provided for display when a refresh rate is set to a relatively slow periodicity (e.g., a relatively slow update interval). In contrast, when the refresh rate is set to a relatively high periodicity (e.g., a relatively fast update interval resulting in frequent updating of a user interface), a client device may cause excessive network traffic associated with requesting and receiving updated data that includes no new information.

Some implementations described herein provide for adaptive data rendering using artificial intelligence or machine learning (AI/ML) models. Artificial intelligence describes different ways that a machine interacts with an environment. Through advanced, human-like intelligence (e.g., provided by software and hardware), an artificial intelligence system may perceive an environment and take actions that maximize a chance of achieving goals. Machine learning is an approach, or a subset of artificial intelligence, with an emphasis on learning rather than just computer programming. A machine learning system may utilize complex models to analyze a massive amount of data, recognize patterns among the data, and generate an output (e.g., a prediction, a classification, or the like) without requiring a human to program specific instructions. Accordingly, an adaptive rendering system may use AI/ML models, trained on user interactions with user interfaces, to predict which components a user is going to interact with in the future and dynamically update the predicted components with greater frequency than components with which a user is not predicted to interact. In this way, an adaptive rendering system ensures that out-of-date data is not provided via a user interface and that excessive network traffic is not generated as a result of overly frequent updates to components with which a user is not interacting. In this way, the AI/ML model enables the adaptive rendering system to perform operations while conserving computing resources and reducing delays that would otherwise result from manual or static updating processes. Furthermore, the use of computing resources and network resources is reduced in connection with serving, generating, and/or displaying the user interface(s).

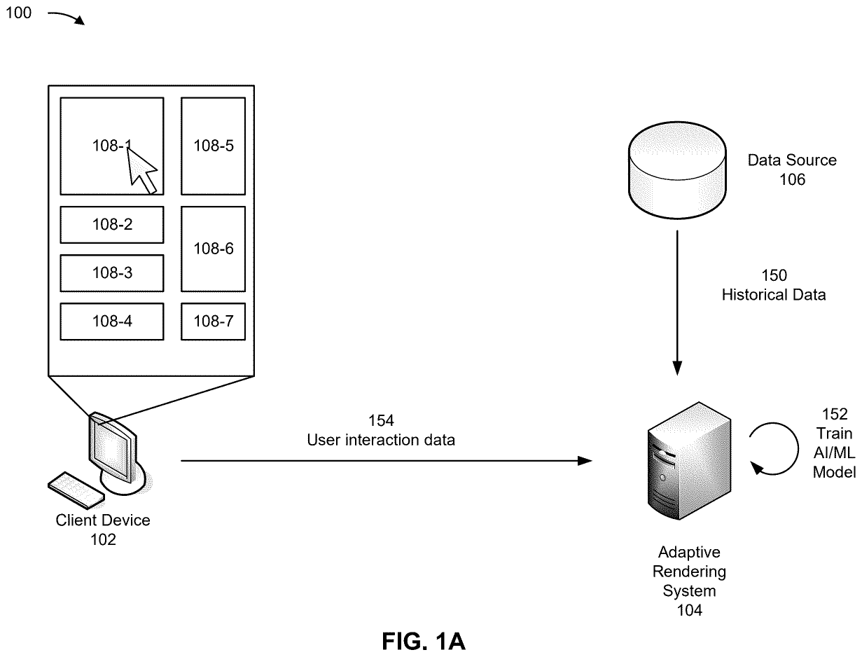

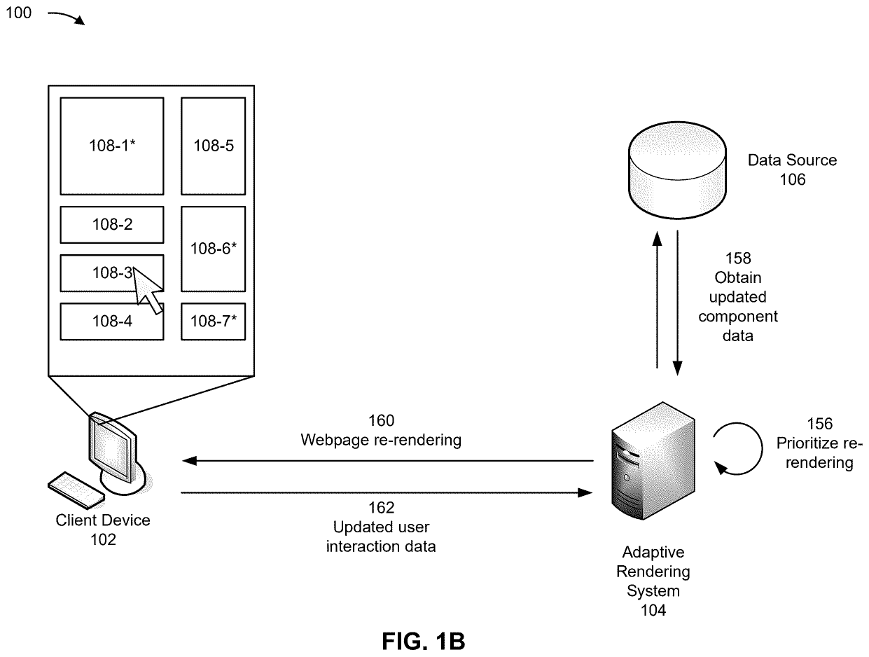

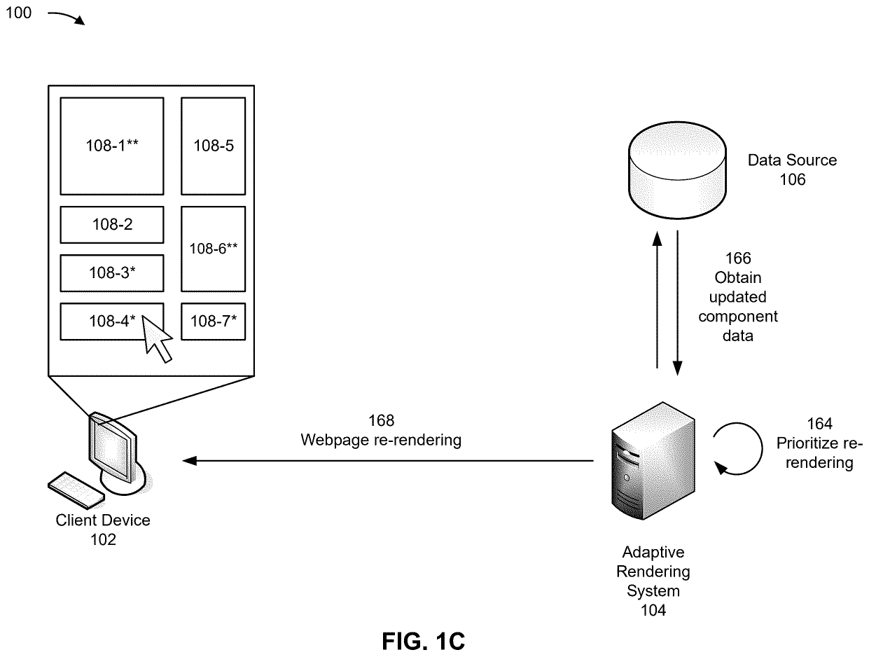

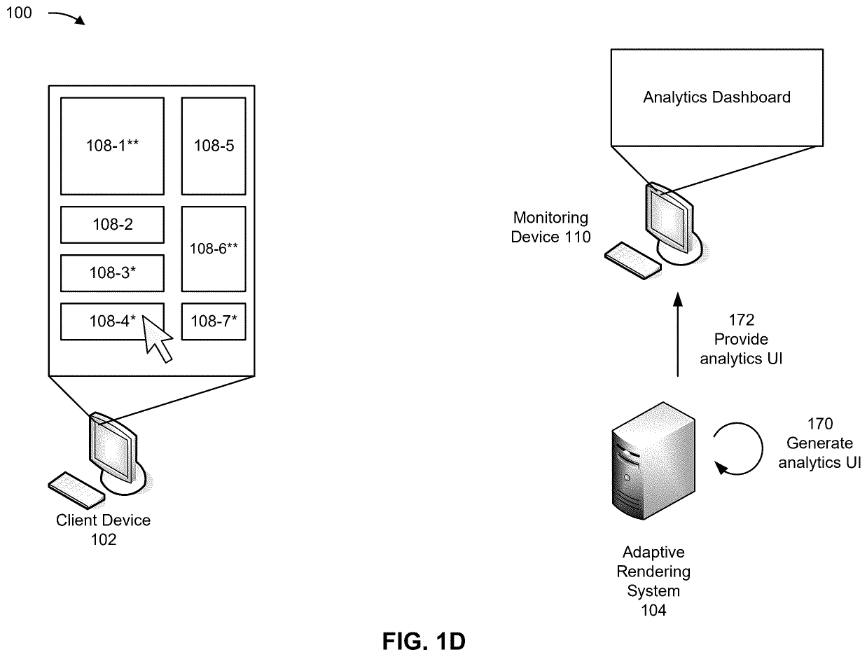

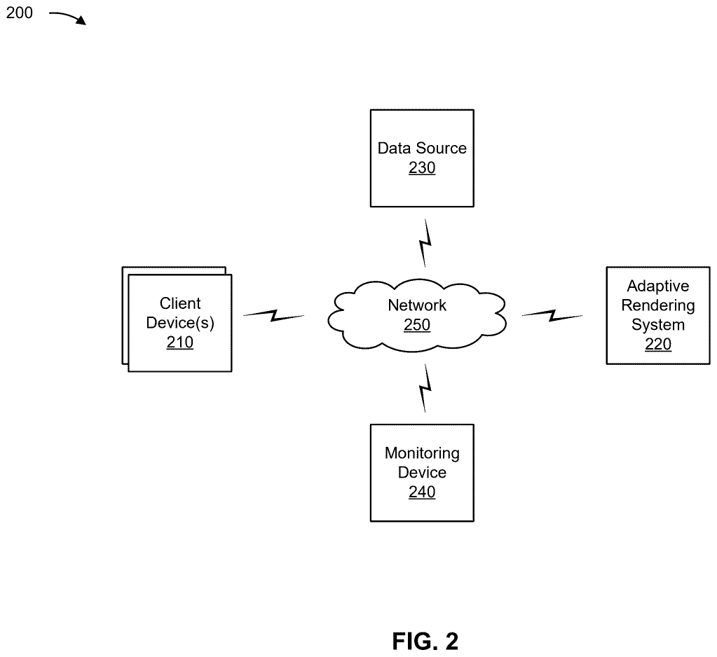

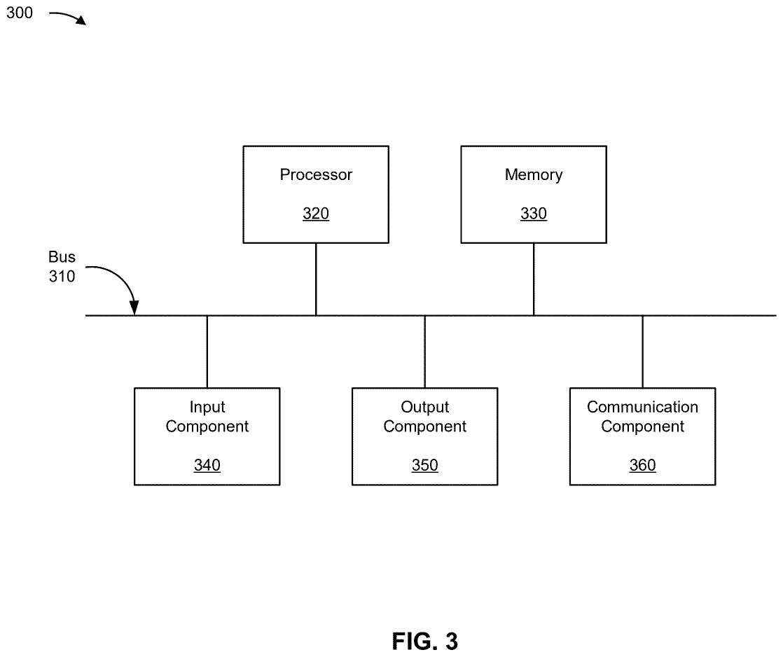

FIGS. 1A-1D are diagrams of an example 100 associated with adaptive, component-level data rendering using predictive models. As shown in FIGS. 1A-1D, example 100 includes a client device 102, an adaptive rendering system 104, a data source 106, and a monitoring device 110. These devices are described in more detail in connection with FIGS. 2 and 3.

As further shown in FIG. 1A, and by reference numbers 150 and 152, the adaptive rendering system 104 may obtain historical data and train an AI/ML model. For example, the adaptive rendering system 104 may request and receive historical data from the data source 106, which may store user interaction data relating to use of a user interface, such as a website or webpage. In this case, the client device 102 may monitor utilization of a user interface to generate the user interaction data.

Additionally, or alternatively, the adaptive rendering system 104 may request and receive historical data relating to component updating. For example, the adaptive rendering system 104 may receive historical data identifying a frequency with which different datasets, which can be provided via a component of a website, are updated. A component may refer to content provided via a website, such as a data visualization, a video feed, an image, an audio file, a layout of text, or another type of content. In some implementations, the adaptive rendering system 104 may receive historical data relating to a particular client device 102 or user thereof. For example, the adaptive rendering system 104 may receive historical data relating to user interactions with a website by the particular client device 102 or user thereof. Additionally, or alternatively, the adaptive rendering system 104 may receive historical data relating to user interactions with the website by many client devices 102 or users thereof.

In some implementations, the adaptive rendering system 104 may train an AI/ML model using the historical data. For example, the adaptive rendering system 104 may train a predictive model associated with predicting future user interactions with a user interface (e.g., a website) based on a set of inputs, such as a set of previous user interactions, a mouse position, or other tracking data. Additionally, or alternatively, the adaptive rendering system 104 may train a predictive model associated with predicting data update frequency. For example, the adaptive rendering system 104 may train a model to use inputs, such as a type of dataset, a content of a dataset, a recency with which the dataset has been changed (e.g., data has changed within the dataset), to generate an output prediction of when a next update to the dataset is to occur.

In some implementations, the adaptive rendering system 104 may train a particular type of AI/ML model or neural network model using the historical user interaction data. For example, the adaptive rendering system 104 may train a visual attention prediction or eye tracking simulation model associated with predicting where a user of client device 102 will look on a website (e.g., to prioritize updating of components at which the user will look). In this case, the adaptive rendering system 104 may train a saliency prediction model, a gaze estimation model, a behavior prediction model, a gradient boosted tree model, or a reinforcement learning model, among other examples. Additionally, or alternatively, the adaptive rendering system 104, to predict a frequency with which a dataset have new data, may train a time-series forecasting model, an anomaly detection model, an event-driven machine learning model, or a reinforcement learning model, among other examples. In some implementations, the adaptive rendering system 104 may use a federated learning model that refines predictions over time without centralizing user data, thereby improving security of user data.

As further shown in FIG. 1A, and by reference number 154, the adaptive rendering system 104 may receive user interaction data. For example, the adaptive rendering system 104 may receive, in real-time or near-real-time from the client device 102, information identifying one or more user interactions with a user interface. The user interaction data may include clickstream data, such as mouse clicks, link clicks, mouse movements, mouse hover-overs, or mouse scrolling behavior, among other examples. Additionally, or alternatively, the user interaction data may include navigation data, such as data identifying which webpages are being viewed, a viewport or gaze direction with respect to a user interface, a duration of viewing, or which page is being viewed before exiting a website. Additionally, or alternatively, the user interaction data may include input data, such as text inputs, typing speed data, or auto-fill usage, among other examples. In some implementations, the user interaction data may include device data, such as a device type, a device processing capability, a browser type, or a display type. In some implementations, the user interaction data may include user data, such as a user identity, a user location, or a time of day, among other examples. In some implementations, the user interaction data may include network data, such as a network connection speed, a latency, a throughput, or a quality of service (QoS) metric, among other examples. In some implementations, the adaptive rendering system 104 may use one or more trackers or event listeners to obtain user interaction data from the client device 102.

In some implementations, the adaptive rendering system 104 may receive user interaction data based on a triggering event. For example, when a user interacts with a component, the client device 102 may provide user interaction data to enable the adaptive rendering system 104 to predict a next component with which the user is to interact. Additionally, or alternatively, when a website or webpage is refreshed, the adaptive rendering system 104 may receive user interaction data to enable prioritization of which components to re-render first when refreshing. Additionally, or alternatively, when a webpage or website is first loaded, the adaptive rendering system 104 may generate a prediction of which components are to be interacted with first and may prioritize the predicted components for rendering. Additionally, or alternatively, the adaptive rendering system 104 may pre-emptively use user interaction data to pre-render loading of user interface components before a user interaction occurs therewith. Similarly, the adaptive rendering system 104 may pre-emptively use a frame-skipping logic to deprioritize inactive user interface components or elements and de-prioritize rendering or updating.

As shown in FIG. 1B, and by reference number 156, the adaptive rendering system 104 may prioritize re-rendering of one or more components of a user interface. For example, the adaptive rendering system 104 may use an AI/ML model (e.g., which the adaptive rendering system 104 may execute using an adaptive rendering controller (ARC)) to generate a prioritization or ordering of components to render or re-render in a user interface. In some implementations, the prioritization may include assigning dynamic priority scores (DPSs) to each component, with each dynamic priority score representing a prediction of a frequency of refresh of data of the component, a likelihood of user interaction with the component, or another factor. In other words, the adaptive rendering system 104 may predict which components of a website, shown as components 108-1 through 108-7 in a user interface of the client device 102, are to be re-rendered as a result of being predicted to have new data for rendering and being predicted to be interacted with by a user of the client device 102. In this case, the adaptive rendering system 104 may predict next user interactions with components and preload or pre-render the components with which a user is predicted to interact.

In some implementations, the adaptive rendering system 104 may prioritize components for re-rendering based on a set of different predictions. For example, the adaptive rendering system 104 may generate a first prediction of which components have a threshold likelihood of having new data for rendering during a configured duration of time. In this case, among components that have a threshold likelihood of having new data for rendering, the adaptive rendering system 104 may generate a prediction of likelihoods with which a user may interact with each component (e.g., by viewing each component, clicking on each component, or performing another action via the client device 102). Based on generating the prediction of likelihoods with which the user may interact with each component, the adaptive rendering system 104 may determine an ordering for re-rendering one or more components.

In some implementations, the adaptive rendering system 104 may generate a prioritization between different client devices 102. For example, when multiple client devices 102 are providing access to a set of components (e.g., of a website) and provide user interaction data, the adaptive rendering system 104 may determine which client devices 102 are more active than others in terms of viewing different components or having user interactions. In this case, the adaptive rendering system 104 may prioritize updating components of more active client devices 102 over updating components of less active client devices 102.

In this case, the adaptive rendering system 104 may cause the components to be re-rendered in accordance with the ordering or may select a subset of components that the adaptive rendering system 104 can re-render within a configured time period, using a configured amount of bandwidth, or based on another characteristic. In this case, rather than re-rendering an entirety of a website, the adaptive rendering system 104 re-renders components most likely to have new data and be interacted with, thereby reducing a total amount of re-rendering that is performed, which reduces processing resource utilization and network resource utilization.

As further shown in FIG. 1B, and by reference number 158, the adaptive rendering system 104 may obtain updated component data for re-rendering one or more components of the user interface. For example, the adaptive rendering system 104 may request and receive updated datasets for rendering within one or more components of a user interface (e.g., a website or webpage). In some implementations, the adaptive rendering system 104 may adjust an ordering for re-rendering based on obtaining the updated component data. For example, when the adaptive rendering system 104 determines that a component does not include a data change, the adaptive rendering system 104 may forgo re-rendering the component and may select another component for re-rendering. By predicting which components are likely to have new data for rendering, the adaptive rendering system 104 may reduce a quantity of requests for updated component data, relative to requesting information regarding all components from the data source 106.

In some implementations, the adaptive rendering system 104 may generate another prediction relating to rendering of a component. For example, the adaptive rendering system 104 may generate a prediction of a layout for rendering of a component. In this case, using user interaction data, the adaptive rendering system 104 may pre-emptively adjust text sizes or contrast settings to improve readability of data presented via a component. Additionally, or alternatively, the adaptive rendering system 104 may generate a prediction relating to a connection usage. For example, the adaptive rendering system 104 may predict a network status of a set of network connections and may determine that different data is to be transmitted via different network connections, such as high priority data for high priority components being conveyed via more reliable or less congested connections, and low priority data for low priority components being conveyed via less reliable or less congested connections. Additionally, or alternatively, when a user interface is being shared among multiple client devices 102, the adaptive rendering system 104 may generate a prioritization among the multiple client devices 102 for which client device 102 gets data updated first in the user interface and which client device 102 gets data updated second in the user interface. Additionally, or alternatively, the adaptive rendering system 104 may generate a prediction relating to changing client devices 102. For example, when a user switches between a first type of client device 102 and a second type of client device 102, the adaptive rendering system 104 may generate a prediction relating to which data to update or render first on the second type of client device 102 (e.g., which may be different from a prioritization when using the first type of client device 102).

As further shown in FIG. 1B, and by reference number 160, the adaptive rendering system 104 may transmit an instruction associated with re-rendering the user interface. For example, the adaptive rendering system 104 may re-render the user interface and may provide the re-rendered user interface to the client device 102 for display. Additionally, or alternatively, the adaptive rendering system 104 may provide the updated component data for one or more components and may instruct the client device 102 to re-render the one or more components in a particular order (e.g., in accordance with a generated prioritization). As shown in FIG. 1B, the adaptive rendering system 104 causes the client device 102 to re-render components 108-1, 108-6, and 108-7. However, a user interacts with a component 108-3. Accordingly, the client device 102 transmits updated user interaction data to the adaptive rendering system 104, as shown by reference number 162.

As shown in FIG. 1C, and by reference number 164, the adaptive rendering system 104 may re-prioritize re-rendering of one or more components of a user interface. For example, based on the updated user interaction data, the adaptive rendering system 104 may generate a new prioritization of components for re-rendering. Additionally, or alternatively, the adaptive rendering system 104 may re-train an AI/ML model based on the updated user interaction data, thereby improving an accuracy of the AI/ML model over time. As shown by reference number 166, the adaptive rendering system 104 may obtain updated component data for re-rendering one or more components of the user interface. For example, based on generating a new prioritization of components for re-rendering, the adaptive rendering system 104 may communicate with the data source 106 to obtain updated data for rendering in one or more components. As shown by reference number 168, the adaptive rendering system 104 may transmit an instruction associated with re-rendering the user interface. For example, the adaptive rendering system 104 may re-render one or more components or may provide updated data to cause the client device 102 to re-render the one or more components. As shown, the adaptive rendering system 104 may cause the components 108-3 and 108-4, which were skipped in the first re-rendering, to be re-rendered. Further, the adaptive rendering system 104 may cause the components 108-1 and 108-6, which were re-rendered in the first re-rendering, to be re-rendered again. In other words, based on using a prioritization, a first periodicity with which the components 108-1 and 108-7 are re-rendered is set to a relatively frequent periodicity (e.g., based on a prediction of frequent data updating and/or frequent user interaction), but a second periodicity with which the components 108-2 and 108-5 are re-rendered is set to a relatively infrequent periodicity (e.g., based on a prediction of infrequent data updating and/or infrequent user interaction). In the case of components 108-2 and 108-5, when the datasets or data that is provided via the components 108-2 and 108-5 are updated infrequently (or when the components 108-2 and 108-5 are interacted with infrequently), the adaptive rendering system 104 may store information relating to the components 108-2 and 108-5 in a cache to avoid frequent updating, thereby prioritizing updating for other components. In some implementations, the adaptive rendering system 104 may use a frame-skipping logic to de-prioritize rendering or loading of the components 108-2 and 108-5 or to pause offscreen updates or background tasks relating to the components 108-2 and 108-5, thereby conserving resources, such as power resources, processing resources, or network resources.

In some implementations, the adaptive rendering system 104 may adjust one or more system parameters in connection with a prioritization. For example, the adaptive rendering system 104 may apply computing optimizations, adjust asset quality, or another characteristic of a component based on one or more metrics, such as a prioritization, a device power (e.g., of the client device 102), a network traffic condition, or another factor.

As shown in FIG. 1D, and by reference numbers 170 and 172, the adaptive rendering system 104 may generate and provide an analytics user interface with analytics relating to component rendering. For example, the adaptive rendering system 104 may generate a set of metrics relating to re-rendering and/or network usage and may provide the set of analytics for display via an analytics dashboard of the monitoring device 110.

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented. As shown in FIG. 2, environment 200 may include a client device 210, an adaptive rendering system 220, a data source 230, a monitoring device 240, and a network 250. Devices of environment 200 may interconnect via wired connections, wireless connections, or a combination of wired and wireless connections.

The client device 210 may include one or more devices capable of receiving, generating, storing, processing, and/or providing information associated with a user interface, as described elsewhere herein. The client device 210 may include a communication device and/or a computing device. For example, the client device 210 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The adaptive rendering system 220 may include one or more devices capable of receiving, generating, storing, processing, providing, and/or routing information associated with adaptive rendering of components of a user interface, as described elsewhere herein. The adaptive rendering system 220 may include a communication device and/or a computing device. For example, the adaptive rendering system 220 may include a server, such as an application server, a client server, a web server, a database server, a host server, a proxy server, a virtual server (e.g., executing on computing hardware), or a server in a cloud computing system. In some implementations, the adaptive rendering system 220 may include computing hardware used in a cloud computing environment, such as one or more serverless components (e.g., one or more serverless functions), among other examples. In some implementations, the adaptive rendering system 220 may be a component of the client device 210. In other words, the adaptive rendering system 220 may execute an application with a lightweight AI/ML model that prioritizes rendering of components for a user interface with or without server-side support.

The data source 230 may include one or more devices capable of receiving, generating, storing, processing, and/or providing information associated with re-rendering components of a user interface, as described elsewhere herein. The data source 230 may include a communication device and/or a computing device. For example, the data source 230 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source 230 may communicate with one or more other devices of environment 200, as described elsewhere herein.

The monitoring device 240 may include one or more devices capable of receiving, generating, storing, processing, and/or providing information associated with monitoring a re-rendering system, as described elsewhere herein. The monitoring device 240 may include a communication device and/or a computing device. For example, the monitoring device 240 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 250 may include one or more wired and/or wireless networks. For example, the network 250 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 250 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with adaptive, component-level data rendering using predictive models. The device 300 corresponds to one or more of the client device 210, the adaptive rendering system 220, the data source 230, and/or the monitoring device 240. In some implementations, the client device 210, the adaptive rendering system 220, the data source 230, and/or the monitoring device 240 include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

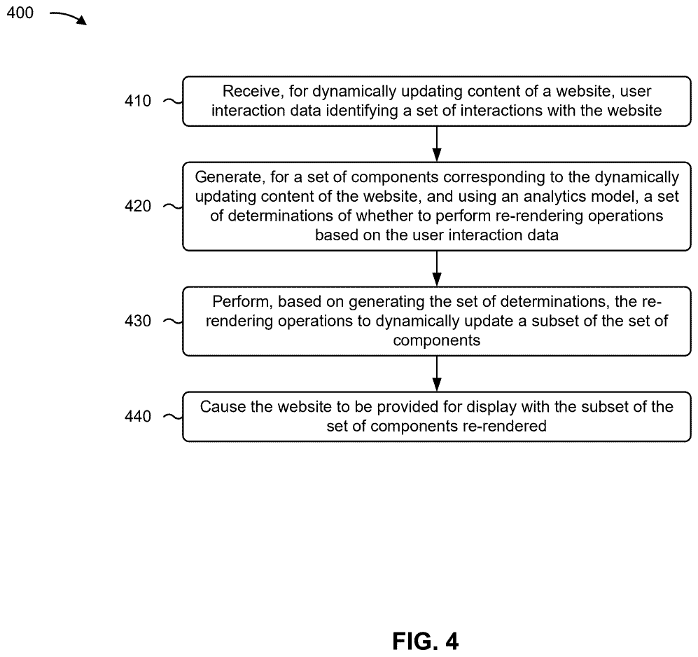

FIG. 4 is a flowchart of an example process 400 associated with adaptive, component-level data rendering using predictive models. In some implementations, one or more process blocks of FIG. 4 may be performed by the adaptive rendering system 220. In some implementations, one or more process blocks of FIG. 4 may be performed by another device or a group of devices separate from or including the adaptive rendering system 220, such as the client device 210, the data source 230, and/or the monitoring device 240. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving, for dynamically updating content of a website, user interaction data identifying a set of interactions with the website (block 410). For example, the adaptive rendering system 220 (e.g., using processor 320, memory 330, input component 340, and/or communication component 360) may receive, for dynamically updating content of a website, user interaction data identifying a set of interactions with the website, as described above in connection with reference number 154 of FIG. 1A. As an example, the adaptive rendering system 220 may receive information identifying a set of mouse movements associated with browsing a website.

As further shown in FIG. 4, process 400 may include generating for a set of components corresponding to the dynamically updating content of the website, and using an analytics model, a set of determinations of whether to perform re-rendering operations based on the user interaction data (block 420). For example, the adaptive rendering system 220 (e.g., using processor 320 and/or memory 330) may generate for a set of components corresponding to the dynamically updating content of the website, and using an analytics model, a set of determinations of whether to perform re-rendering operations based on the user interaction data, as described above in connection with reference number 156 of FIG. 1B. As an example, the adaptive rendering system 220 may prioritize re-rendering of a set of components of the website based on a set of predictions regarding future mouse movements or mouse clicks on the website.

As further shown in FIG. 4, process 400 may include performing, based on generating the set of determinations, the re-rendering operations to dynamically update a subset of the set of components (block 430). For example, the adaptive rendering system 220 (e.g., using processor 320 and/or memory 330) may perform, based on generating the set of determinations, the re-rendering operations to dynamically update a subset of the set of components, as described above in connection with reference number 160 of FIG. 1B. As an example, the adaptive rendering system 220 may transmit a set of instructions to a client device to cause re-rendering to occur for the subset of the set of components.

As further shown in FIG. 4, process 400 may include causing the website to be provided for display with the subset of the set of components re-rendered (block 440). For example, the adaptive rendering system 220 (e.g., using processor 320 and/or memory 330) may cause the website to be provided for display with the subset of the set of components re-rendered, as described above in connection with reference number 160 of FIG. 1B. As an example, the adaptive rendering system 220 may instruct the client device to provide the website for display with the subset of the set of components re-rendered with updated data.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for data rendering, the system comprising:
one or more memories; and
one or more processors, communicatively coupled to the one or more memories, configured to:
receive, for a user interface, user interaction data identifying a set of interactions with the user interface;
generate, for a set of components of a rendered user interface and using an artificial intelligence or machine learning (AI/ML) model, an ordering based on the user interaction data,
wherein the ordering is indicative of a likelihood of a future interaction with a corresponding component, of the set of components;
determine, for the set of components, to perform a re-rendering operation for the rendered user interface based on the ordering;
instruct, based on determining whether to perform the re-rendering operation, a rendering engine to re-render at least a subset of the set of components to generate a re-rendered user interface; and
cause the re-rendered user interface to be provided for display with at least the subset of the set of components.

2. The system of claim 1, wherein the one or more processors are further configured to:
determine, based on the user interaction data, an update interval for re-rendering; and
periodically re-render the user interface based on the update interval.

3. The system of claim 1, wherein the one or more processors, to generate the ordering, are configured to:
assign, to the set of components, a set of dynamic priority scores, wherein the set of dynamic priority scores represent a set of frequencies of refresh of the set of components with respect to user interaction and data updating; and
generate the ordering based on the set of dynamic priority scores.

4. The system of claim 1, wherein the one or more processors are further configured to:
obtain historical user interaction data; and
generate, using a neural network technique, the AI/ML model, based on the historical user interaction data, wherein the AI/ML model includes a prediction model of a likelihood that a particular component is selected and includes new data for re-rendering.

5. The system of claim 1, wherein the one or more processors, to instruct the rendering engine to re-render the at least the subset of the set of components, are configured to:
instruct the rendering engine to skip, in accordance with a frame-skipping logic, rendering one or more frames for one or more components of the set of components.

6. The system of claim 1, wherein the one or more processors are further configured to:
determine that the re-rendering operation satisfies a resource condition;
identify, based on determining that the re-rendering of the user interface satisfies the resource condition, one or more background tasks; and
adjust a performance level associated with the one or more background tasks to prioritize the re-rendering operation.

7. The system of claim 1, wherein the one or more processors are further configured to:
select, based on the ordering, the at least the subset of the set of components for the re-rendering operation; and
wherein the one or more processors, to instruct the rendering engine to re-render the at least the subset of the set of components, are configured to:
instruct the rendering engine based on selecting the at least the subset of the set of components.

8. The system of claim 7, wherein the selection of at least the subset of the set of components is based on a device power characteristic or a network condition characteristic.

9. The system of claim 7, wherein the one or more processors are further configured to:
generate an analytics dashboard identifying a set of metrics relating to the re-rendering operation; and
provide, for display, the analytics dashboard.

10. A non-transitory computer-readable medium storing a set of instructions, the set of instructions comprising:
one or more instructions that, when executed by one or more processors of a system, cause the system to:
receive, from a client device and for a webpage, user interaction data identifying a set of interactions with a user interface that provides the webpage;
generate, for a set of components of the webpage and using an artificial intelligence or machine learning (AI/ML) model, a set of priorities based on the user interaction data;
select a subset of the set of components for which to perform a re-rendering operation in accordance with the set of priorities;
re-render, based on selecting the subset of the set of components, the webpage, wherein the webpage includes a first portion, corresponding to the subset of the set of components, that is re-rendered, and a second portion, corresponding to a remainder of the set of components, that is not re-rendered; and
provide the webpage for display via the user interface based on re-rendering the webpage.

11. The non-transitory computer-readable medium of claim 10, wherein the one or more instructions, that cause the system to receive the user interaction data, cause the system to:
monitor utilization of the user interface to generate the user interaction data.

12. The non-transitory computer-readable medium of claim 10, wherein the user interaction data includes at least one of:
mouse click information,
mouse hover-over information, or
scroll information.

13. The non-transitory computer-readable medium of claim 10, wherein the one or more instructions, that cause the system to generate the set of priorities, cause the system to:
apply a set of weights to different types of interactions of the user interaction data; and
generate the set of priorities based on applying the set of weights.

14. The non-transitory computer-readable medium of claim 10, wherein the one or more instructions further cause the system to:
determine, based on the user interaction data, an update interval for re-rendering; and
periodically re-render the webpage based on the update interval.

15. The non-transitory computer-readable medium of claim 10, wherein the one or more instructions, when executed by the one or more processors, cause the system to:
generate an ordering for re-rendering the webpage based on the set of priorities.

16. The non-transitory computer-readable medium of claim 10, wherein the one or more instructions further cause the system to:
obtain historical user interaction data; and
generate, using a neural network technique, the AI/ML model, based on the historical user interaction data, wherein the AI/ML model includes a prediction model of a likelihood that a particular component is selected and includes new data for re-rendering.

17. The non-transitory computer-readable medium of claim 10, wherein the one or more instructions, that cause the system to re-render the webpage, cause the system to:
skip, in accordance with a frame-skipping logic, rendering one or more frames for one or more components of the set of components.

18. The non-transitory computer-readable medium of claim 10, wherein the one or more instructions further cause the system to:
determine that the re-rendering satisfies a threshold resource condition;
identify, based on determining that the re-rendering satisfies the threshold resource condition, one or more background tasks; and
adjust a performance level associated with the one or more background tasks to prioritize the re-rendering.

19. A method for adaptive webpage rendering, comprising:
receiving, by a system, for dynamically updating content of a website, user interaction data identifying a set of interactions with the website;
generating, by the system, for a set of components corresponding to the dynamically updating content of the website, and using an analytics model, a set of determinations of whether to perform re-rendering operations based on the user interaction data;
performing, by the system and based on generating the set of determinations, the re-rendering operations to dynamically update a subset of the set of components; and
causing, by the system, the website to be provided for display with the subset of the set of components re-rendered.

20. The method of claim 19, further comprising:
determining, based on the user interaction data, an update interval for re-rendering; and
periodically re-render another subset of the set of components based on the update interval.
